(19) United States
(12) Patent Application Publication
(10) Pub. No.: US 2016/0285845 A1
(43) Pub. Date: Sep. 29, 2016

(54) METHOD FOR SETTING UP, VIA AN INTERMEDIATE ENTITY, A SECURE SESSION BETWEEN A FIRST AND A SECOND ENTITY, AND CORRESPONDING ENTITIES AND COMPUTER PROGRAM PRODUCTS

(71) Applicant: UBIQU B.V., Rotterdam (NL)

(72) Inventor: Boris Petrov Dokov GORANOV, Rotterdam (NL)

(21) Appl. No.: 15/032,898

(22) PCT Filed: Oct. 31, 2014
(86) PCT No.: PCT/NL2014/050755

§ 371 Date: Apr. 28, 2016

(30) Foreign Application Priority Data
Oct. 31, 2013 (NL) 2011717

(51) Int. Cl. H04L 29/06

(52) U.S. Cl. CPC H04L 63/08; H04L 63/10; H04L 63/06

(57) ABSTRACT

The invention relates to a method for setting up a secure session between a first entity and a second entity. In an embodiment, the first entity is a user authentication device and the second entity is an application running on a platform. The method comprises generating a first random number. A user enters a first string, derived from said first number, into the second entity. Further, the method includes applying a one-way function to the first string or to a derivative thereof, obtaining an encoded string. The method also comprises transmitting the encoded string to an intermediate node that is in connection to the first entity and the second entity. Further, the method comprises the step of sharing a second random number with the second entity. The method also comprises a step of deriving a secret key from the first and the second string.

The present invention relates to a method for setting up a secure session between a first and a second entity.

For the purpose of secure exchange of information on the Internet, e.g. for enabling reliable access to data, safe information storage, processing and distribution, a secure session between entities on the Internet is indispensable. As an example, a safe session has to be established, and optionally maintained, between a server on which an application is running and a user workplace, such as a PC or tablet.

It is an object of the invention to provide a method of setting up a secure session between a first and a second entity, safely and quickly. Thereto, according to the invention, a method is provided for setting up a secure session between a first entity and a second entity, the first and second entity being a user authentication device and an application running on a platform, respectively, or vice versa, the method being performed by a first entity and comprising the steps of generating a first random number, exporting a first string derived from said first random number, to a user for entering the first string into a second entity, applying a one-way function to the first string or to a derivative thereof, obtaining an encoded string, transmitting the encoded string to an intermediate node that is in connection to the first entity and a second entity, the method further comprising the steps of generating a second random number, deriving a second string from said second random number and transmitting the second string to the second entity if a verifying step of comparing encoded strings transmitted by the first entity and the second entity has a positive result, or receiving from the second entity a second string being derived from a second random number generated by the second entity, the method further comprising the step of deriving a secret key from the first and the second string.

By forwarding encoded strings to an intermediate node, it can be verified that the first and second entity share unique information in the form of the first string, even if said unique information is not known to the intermediate node. Then, a secure data transmission channel can be established from the first entity via the intermediate node to the second entity, and vice versa. By further sharing a second unique string, the first and second entity can derive a unique key that is only known to said first and second entity, thereby enabling a secure information exchange via said established transmission channel.

The invention also relates to a method being performed by the second entity, and to a method being performed by the intermediate node that is in connection to the first entity and the second entity.

In addition, the invention relates to a first entity, a second entity and an intermediate node that is in connection to the first and the second entity.

Further, the invention relates to computer program products. A computer program product may comprise a set of computer executable instructions stored on a data carrier, such as a CD or a DVD. The set of computer executable instructions, which allow a programmable computer to carry out the methods as defined above, may also be available for downloading from a remote server, for example via the Internet or via an app.

Other advantageous embodiments according to the invention are described in the following claims

By way of example only, embodiments of the present invention will now be described with reference to the accompanying figures in which

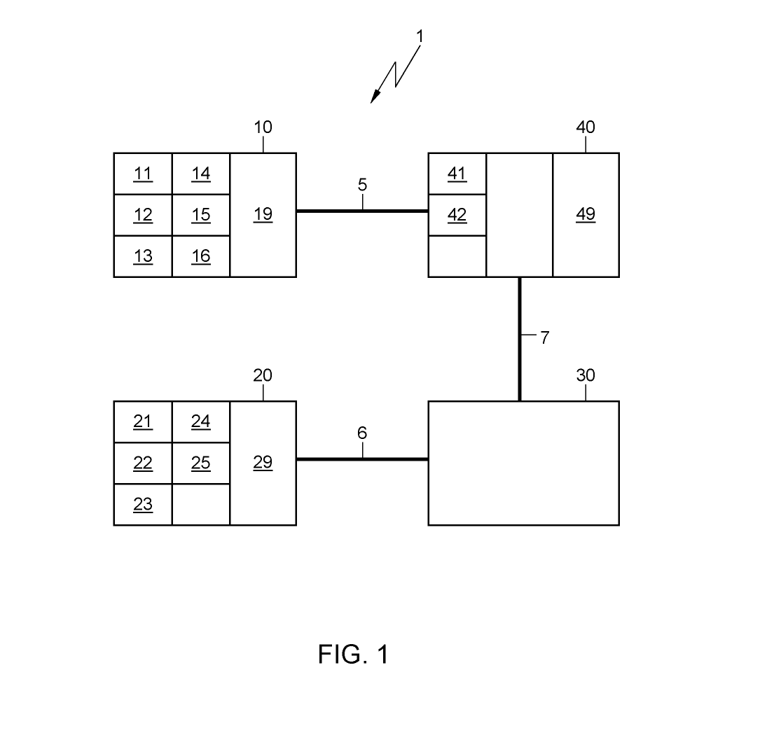

FIG. 1 shows a network comprising a first entity according to the invention, a second entity according to the invention and an intermediate node according to the invention;

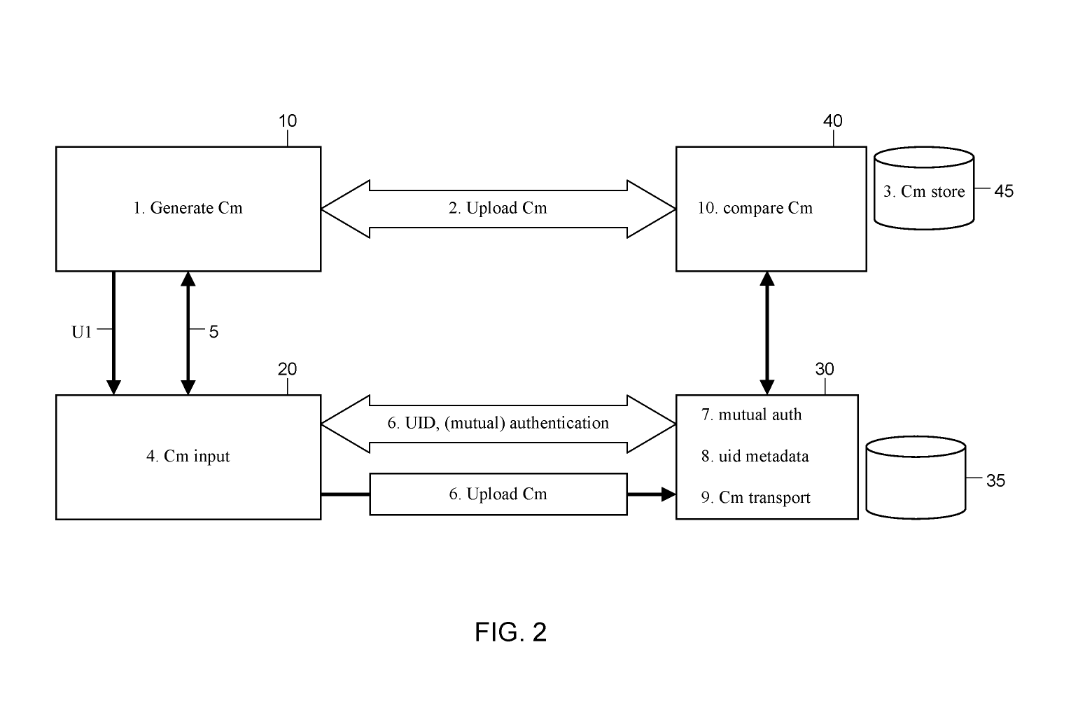

FIG. 2 shows a first process diagram according to the invention;

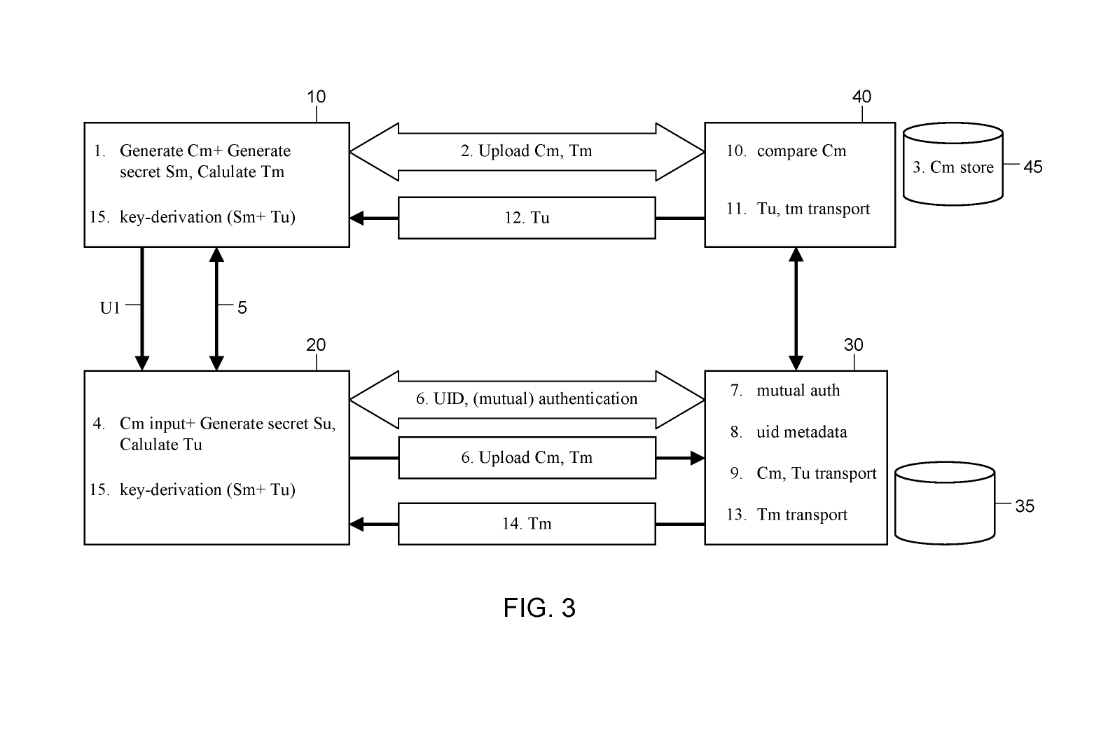

FIG. 3 shows a second process diagram according to the invention;

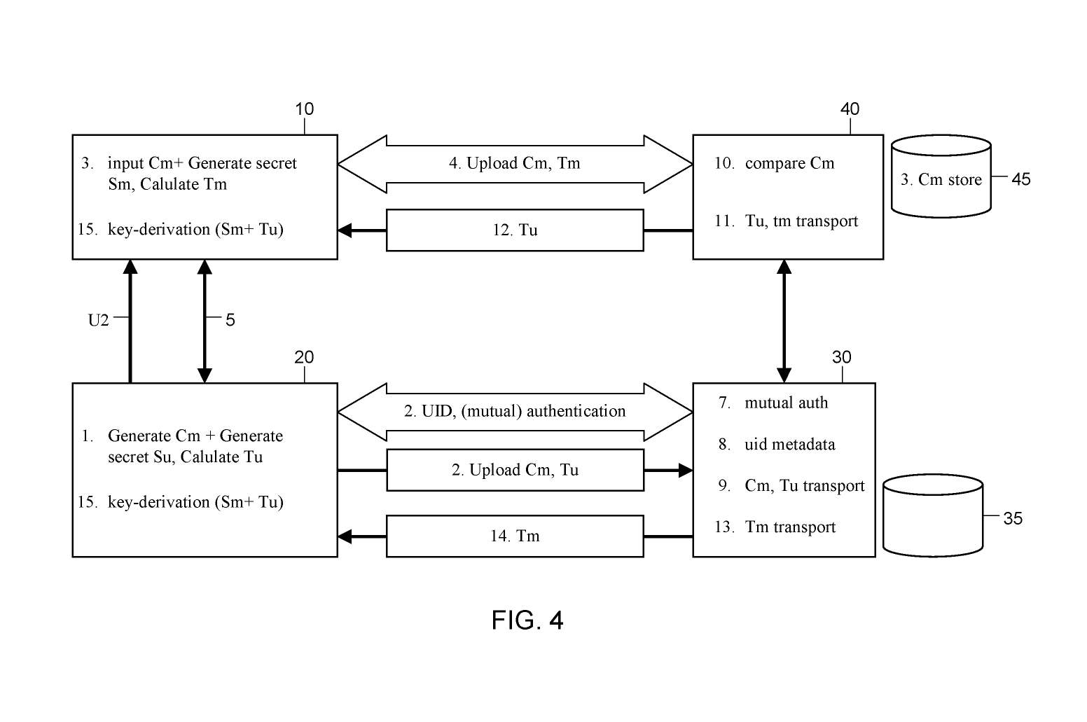

FIG. 4 shows a third process diagram according to the invention;

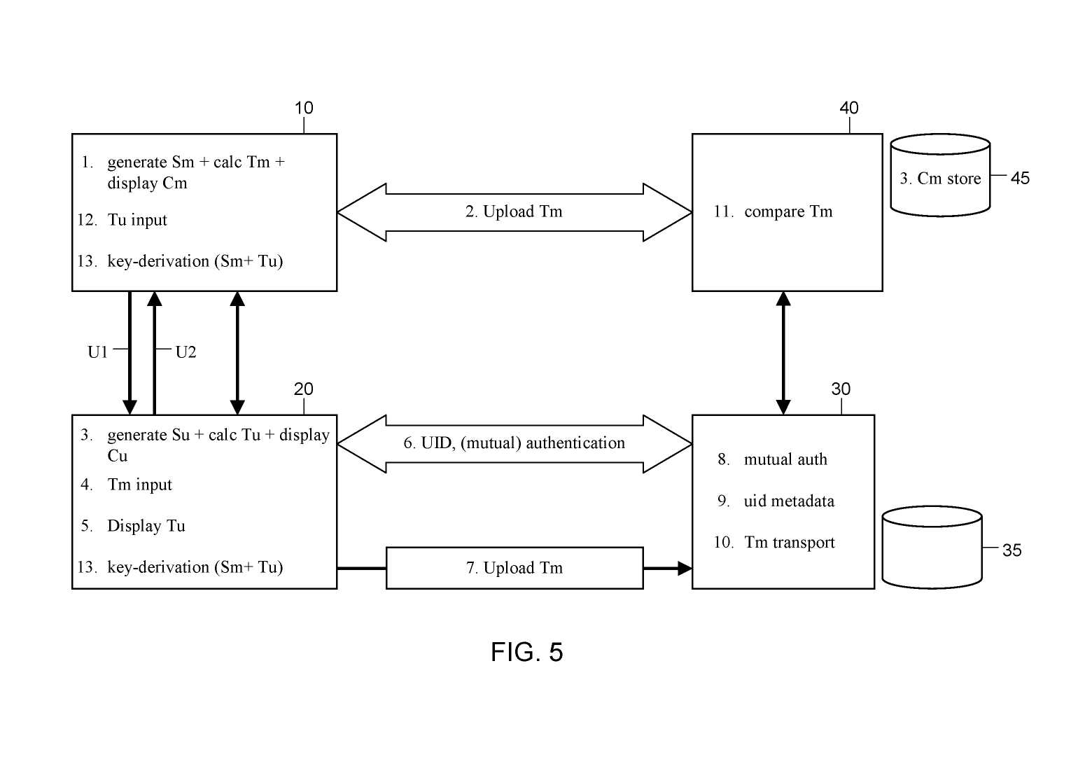

FIG. 5 shows a fourth process diagram according to the invention;

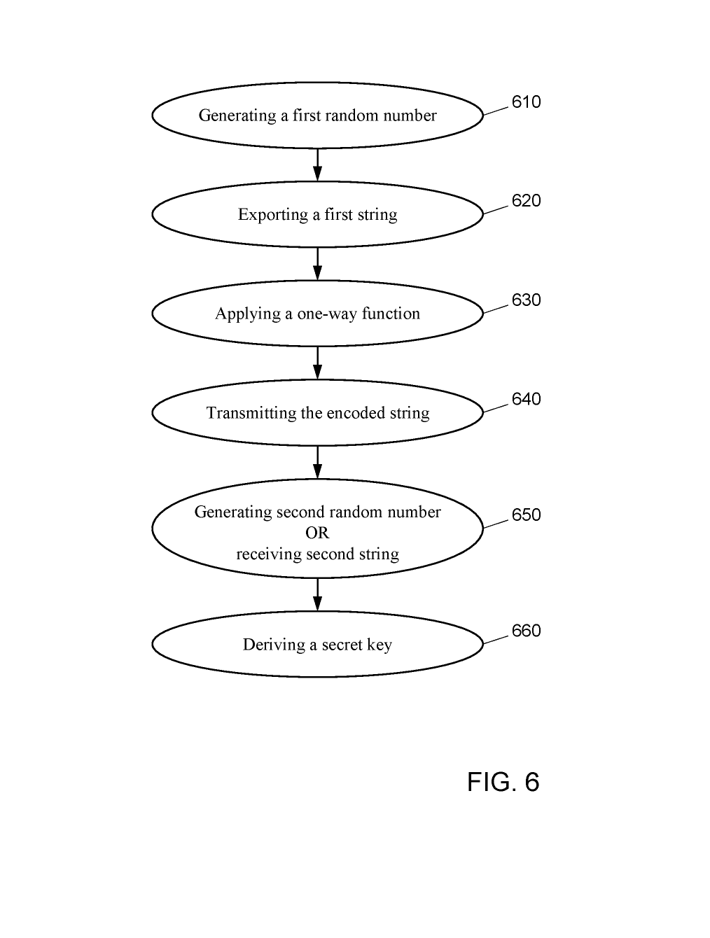

FIG. 6 shows a flow chart of a method according to the invention being performed on the first entity shown in FIG. 1;

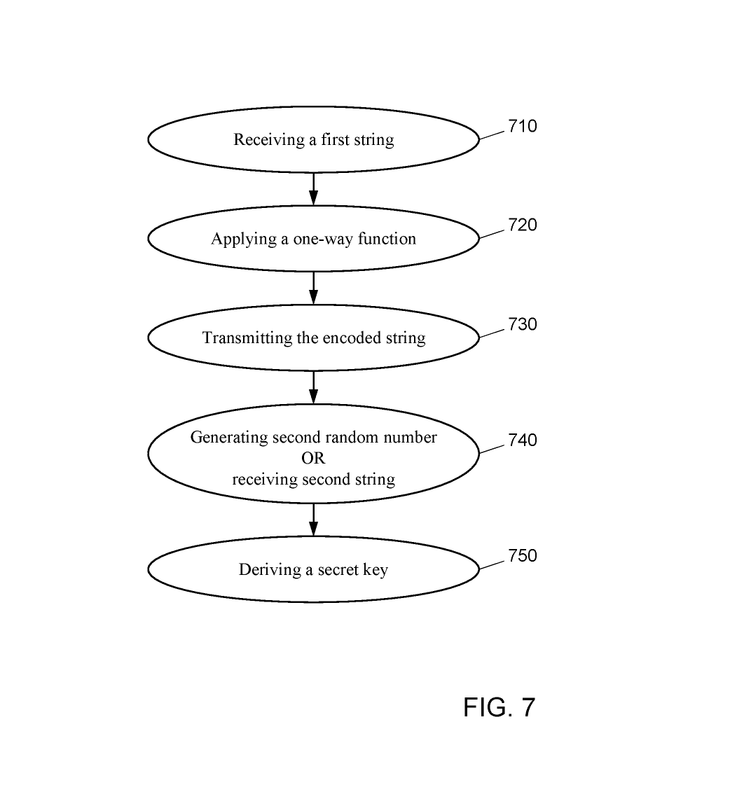

FIG. 7 shows a flow chart of a method according to the invention being performed on the second entity shown in FIG. 1; and

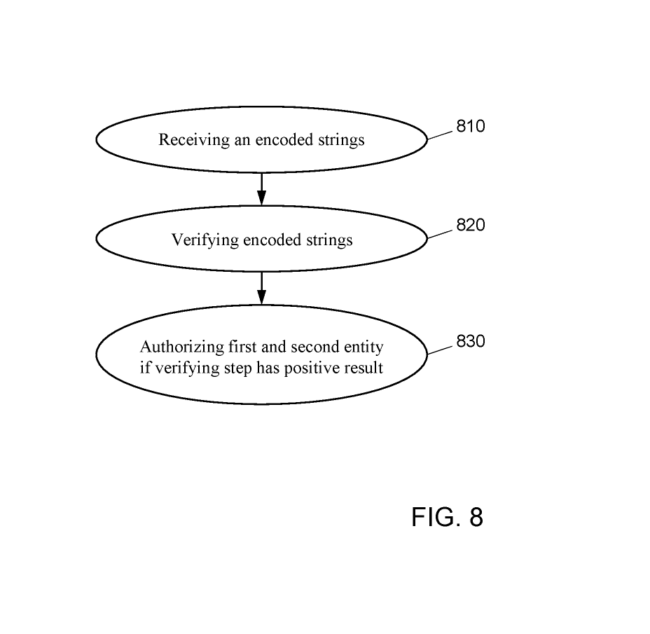

FIG. 8 shows a flow chart of a method according to the invention being performed on the intermediate node shown in FIG. 1.

It is noted that the figures show merely a preferred embodiment according to the invention. In the figures, the same reference numbers refer to equal or corresponding parts.

FIG. 1 shows a network 1 comprising a first entity 10 according to the invention, a second entity 20 according to the invention and an intermediate node 40 according to the invention. In the shown embodiment the first entity 10 is a user workplace application, such as a PC, a tablet, a cash desk or another application that is running on a hardware device operated by a user. Further, in the shown embodiment, the second entity 20 is a user authentication device, such as a cellular phone, a PDA, a smart card, a token, an electronic key or another personal device serving for authentication purposes. The network 1 also comprises an authentication server 30 associated with the second entity 20. Further, the network 1 comprises a first data transmission path 5 connecting the user workplace application 10 to the intermediate node 40, a second data transmission path 6 connecting the second entity 20 to the authentication server 30, and a third data transmission path 7 connecting the intermediate node 40 to the authentication server 30.

The first entity 10 is provided with a number of modules for setting up a secure session with a second entity 20 as described below. Thereto the first entity 10 includes a first random generator 11 for generating a first random number, an I/O interface 12 for exporting a first string derived from said first random number, to a user for entering the first string into a second entity 20, a processor 13 for applying a one-way function to the first string or to a derivative thereof, obtaining an encoded string, and a transmitting unit 14 for transmitting the encoded string to the intermediate node 40 that is in connection to the first entity 10 and the second entity 20. Further, the first entity 10 includes a receiver unit 15 for receiving from the second entity 20 a second string being derived from a second random number generated by the second entity 20. The processor 13 is further arranged for deriving a secret key from the first and the second string. Optionally, the first entity 10 is provided with a second random generator 16 for generating a second random number as described below.

Also the second entity 20 is provided with a number of modules for facilitating a procedure of setting up a secure session with the first entity 10. Thereto, the second entity 20 includes an I/O interface 21 for receiving a first string derived from a first random number generated by a first entity 10, a processor 22 for applying a one-way function to the first string or to a derivative thereof, obtaining an encoded string, a transmitting unit 23 for transmitting the encoded string to an intermediate node that is in connection to a first and the second entity. Further, the second entity 20 includes a second random generator 24 for generating a second random number. The processor 22 is arranged for deriving a second string from said second random number and for transmitting the second string to the first entity 10 if a verifying step of comparing encoded strings transmitted by the first entity 10 and the second entity 20 has a positive result. The processor 22 is further arranged for deriving a secret key from the first and the second string. In addition, the second entity 20 is provided with a receiver unit 25.

The intermediate node 40 that is in connection to a first and second entity for setting up a secure connection between the first and the second entity 10, 20 comprises a receiving unit 41 for receiving an encoded string from the first and the second entity 10, 20, and a processor 42 for verifying whether the encoded strings received from the first and second entity 10, 20 match to each other. If the encoded strings correspond to each other, a secure session can be set up. The processor 42 is further arranged for authorizing the first and second entity 10, 20 to share a second string being derived from the second random number generated by the second entity 20, if the verifying step has a positive result.

The first entity 10, the second entity 20 and the intermediate node 40 are each provided with a processing unit 19, 29, 49 for controlling operation of the respective entity or node in the network 1.

It is noted that in another embodiment of the invention, the first entity 10 is the user authentication device while the second entity 20 is the platform application. Then, the first entity 10 not only generates the first random number, but also the second random number. The second random number is forwarded as a second string to the second entity 20, either via manually entering the second string into the I/O interface 21 of the second entity 20 or via transmittal of a digital path, preferably in encrypted format. Also in this embodiment, the secure session is set up between a user authentication device and a platform application via a first data transmission path 5, a second data transmission path 6 and a third data transmission path 7. The platform application of the secure session can e.g. be chosen to be a user workplace application, a cloud application, an authentication provider application, or a transaction system application.

The first string derived from the first random number, generated by the first entity 10, can be implemented as a random message produced from said first random number. The first string can also be produced as another representation of the first random number. Alternatively, the first string and the first random number are identical.

Further, the derivative of the first string can be generated by applying a hash function or a similar function to the string. Otherwise, the derivative of the first string is identical to the string itself. A one-way function is applied to the derivative of the first string to obtain an encrypted string.

The second string can be transmitted in an encrypted manner. Alternatively, the second string is exported to a user, e.g. via a display for entering the string in the first or second entity 10, 20.

In the above described embodiment, the intermediate node 40 can be a server on which a specific application is running, e.g. a document management application for managing storage, processing and/or distribution of documents in the cloud. Alternatively, the intermediate node 40 is the authentication provider that is securely connected to the authentication device.

When the secure session between the first and second entity 10, 20 has been established, a secure transmission channel can be used for one-way or two-way data transfer, such as a transfer of a message, a decryption and/or encryption key, or an authorization dialog. Decryption and/or encryption keys can be used to authorize a document in a cloud application.

If the platform application is a transaction system application, a user workplace application is generally remotely connected thereto. Then, a transaction process may be started, including the steps of preparing a persistent transaction instruction on the user workplace application, performing an authorization dialog between the transaction system application and the authentication device, and executing the transaction instruction only when the authorization dialog has successfully finished. The authorization dialog may include the steps of transmitting a code, from the transaction system application to the authentication device for entering the code into the user workplace application, transmitting the code from the user workplace application to the transaction system application, optionally in encrypted format, and verifying whether the code or the encrypted equivalent thereof received by the transaction system application is the same as the code transmitted by said transaction system application, or the encrypted equivalent thereof.

In a specific embodiment according to the invention, the step of transmitting the second string is implemented by exporting the second string to a user, via an I/O interface of one entity 10; 20 for manually entering the second string into an I/O interface of the other entity 20; 10, respectively.

The user authentication device is associated with the authentication server 30 as a result of an identification process that has been performed prior to setting up a secure connection between the first entity 10 and the second entity 20. Then, a secure connection is present between the user authentication device and the associated authentication server 30, so that a user of the authentication device can perform an identity or capacity process in a particular context, e.g. to have access to a safety box.

Advantageously, authentication data can be made available to the intermediate node 40, e.g. in the form of metadata, in order to inform the intermediate node 40 about an identity or capacity of the user authentication device transmitting the encoded string to the intermediate node 40.

FIG. 2 shows a first process diagram according to the invention. Here, the first random number is generated by the first entity 10, a user platform application, uploaded as an encoded string Cm to the intermediate node 40 and stored in an intermediate memory unit 45 associated with the intermediate node 40. The first random number or first string is exported to the user, e.g. via a display, and entered by the user in a first manual user action U₁ into the second entity 20, a user authentication device. Then, the second entity 20 forwards the encoded string Cm and user identification data UID to the authentication server 30 for mutual identification, including retrieval of information from identification metadata stored in an authentication storage unit 35 associated with the authentication server 30, and transport of relevant identification metadata and the first encoded string to the intermediate node 40. Then, the intermediate node 40 performs a verification of the encoded strings received from the first and the second entity 10, 20. If the strings correspond, the intermediate node 40 authorizes the first and second entity 10, 20 to share a second random number for computing a unique key. A secure connection S is set up between the user workplace application and the user authentication device.

FIG. 3 shows a second process diagram according to the invention. Again, the first entity 10, a user workplace application, generates the first random number, and uploads the number as an encoded string Cₘ to the intermediate node 40 for storage in the intermediate memory unit 45. Similar to the process shown in FIG. 2, the first random number or first string is exported to the user, e.g. via a display, and entered by the user in a first manual user action U₁ into the second entity 20, the user authentication device. Here, both the first entity 10 and the second entity 20 derive a secret key Sₘ, Sᵤ and apply the key Sₘ, Sᵤ to the number Cₘ, or equivalent thereof, obtaining the encoded string Tₘ, Tᵤ, encrypted transformations of the random number Cₘ or the equivalent of Cₘ. As an example, a diffie-hellmann key exchange can be applied. The encrypted transformations Tₘ, Tᵤ, are uploaded to the intermediate node 40 and the authentication server 30, respectively. Also, user identification data UID from the second entity 20 is forwarded to the authentication server 30 for mutual identification, including retrieval of information from identification metadata stored in an authentication storage unit 35 associated with the authentication server 30, and transport of relevant identification metadata, the first encoded string Cₘ and the encrypted transformation Tᵤ, to the intermediate node 40. The intermediate node 40 performs a verification of the encoded strings Cₘ received from the first and the second entity 10, 20. If the strings correspond, the intermediate node 40 authorizes the first and second entity 10, 20 to share a second random number. The encoded strings Tₘ, Tᵤ, are uploaded to the second and first entity 20, 10, respectively. Then, both the first and the second entity 10, 20 compute a key based on the encoded strings Tₘ, Tᵤ. A secure connection S is set up between the user workplace application and the user authentication device.

FIG. 4 shows a third process diagram according to the invention. Here, the first random number is generated by the second entity 20, also generating the second random number. The first string derived from said first random number is entered into the first entity 10 via a second manual user action U₂. The process is further similar to the second process explained referring to FIG. 3.

FIG. 5 shows a fourth process diagram according to the invention. Here, two strings are manually entered into the first and the second entity 10, 20. In contrast to the second process where the encrypted transformation Tᵤ is forwarded via the authentication server 30 and the intermediate node 40 to the first entity 10, the encrypted transformation Tᵤ, obtained by applying a secret key Sᵤ to the number Cₘ, or equivalent thereof, is now manually entered to the first entity 10.

In the fourth process diagram, a first random number is generated by the first entity 10. The first random number or first string is exported to the user, e.g. via a display, and entered by the user in a first manual user action U₁ into the second entity 20, the user authentication device. Here, both the first entity 10 and the second entity 20 derive a secret key Sₘ, Sᵤ and apply the key Sₘ, Sᵤ to the number Cₘ, or equivalent thereof, obtaining the encoded string Tₘ, Tᵤ, encrypted transformations of the random number Cₘ or the equivalent of Cₘ. Also the encoded string Tₘ is entered by the user in the first manual user action U₁ into the second entity 20. The encrypted transformation Tₘ and user identification data UID are uploaded from the second entity 20 to the authentication server 30, for mutual identification, including retrieval of information from identification metadata stored in an authentication storage unit 35 associated with the authentication server 30, and transport of relevant identification metadata and the encrypted transformation Tₘ, to the intermediate node 40. The encrypted transformation Tₘ is also uploaded from the first entity 10 to the intermediate node 40. The intermediate node 40 performs a verification of the encoded strings Cₘ received from the first and the second entity 10, 20. If the strings correspond, the intermediate node 40 authorizes the first and second entity 10, 20 to share a second random number.

The encrypted transformation Tᵤ, obtained by applying a secret key Sᵤ to the number Cₘ, or equivalent thereof, is manually entered to the first entity 10 via a second manual user action U₂. Based on the encoded strings Tₘ, Tᵤ, both the first and the second entity 10, 20 compute a key. A secure connection S is set up between the user workplace application and the user authentication device. Here, the second string is transferred via the second manual user action U₂.

It is noted that the secure session can be set up between the user authentication device and a user platform application, such as a user workplace application, a cloud application, an authentication provider or a transaction application.

FIG. 6 shows a flow chart of a method according to the invention being performed on a first entity. The method is applied for setting up a secure session between a first entity and a second entity, the first and second entity being a user authentication device and an application running on a platform, respectively, or vice versa, the method being performed by a first entity. The method comprises a step of generating 610 a first random number, a step of exporting 620 a first string derived from said first random number, to a user for entering the first string into a second entity, a step of applying 630 a one-way function to the first string or to a derivative thereof, obtaining an encoded string, a step of transmitting 640 the encoded string to an intermediate node that is in connection to the first entity and a second entity. The method further comprises the steps of generating 650 a second random number, deriving a second string from said second random number and transmitting the second string to the second entity if a verifying step of comparing encoded strings transmitted by the first entity and the second entity has a positive result, or the step of receiving from the second entity a second string being derived from a second random number generated by the second entity. Further, the method comprises the step of deriving 660 a secret key from the first and the second string.

FIG. 7 shows a flow chart of a method according to the invention being performed on a second entity. The method is applied for setting up a secure session between a first entity and a second entity, the first and second entity being a user authentication device and an application running on a platform, respectively, or vice versa, the method being performed by a second entity. The method comprises a step of receiving 710, via an I/O interface, a first string derived from a first random number generated by a first entity, a step of applying 720 a one-way function to the first string or to a derivative thereof, obtaining an encoded string, a step of transmitting 730 the encoded string to an intermediate node that is in connection to a first and the second entity. Further, the method comprises the steps of generating 740 a second random number, deriving a second string from said second random number and transmitting the second string to the first entity if a verifying step of comparing encoded strings transmitted by the first entity and the second entity has a positive result, or the step of receiving from the first entity a second string being derived from a second random number generated by the first entity. The method further comprises a step of deriving 750 a secret key from the first and the second string.

FIG. 8 shows a flow chart of a method according to the invention being performed on an intermediate node that is in connection to a first entity and a second entity. The method is applied for setting up a secure session between a first entity and a second entity, the first and second entity being a user authentication device and an application running on a platform, respectively, or vice versa, the method being performed by an intermediate node. The method comprises a step of receiving 810 an encoded string from a first and second entity, the encoded string being obtained by applying a one-way function to a first string or to a derivative thereof, the first string being derived from a first random number generated by a first entity, a step of verifying 820 whether the encoded strings received from the first and second entity are the same, and a step of authorizing 830 the first and second entity to share a second string being derived from a second random number generated by the first or second entity, respectively, if the verifying step has a positive result.

The above defined methods can be performed using dedicated hardware structures, such as FPGA and/or ASIC components. Otherwise, the methods can also at least partially be performed using a computer program product comprising instructions for causing a processing unit of the first entity, the second entity and the intermediate node to perform the above described steps of the methods according to the invention. All steps of a method can in principle be performed on a single processor. However, it is noted that in advantageous embodiments according to the invention, steps are performed on separate processing units. As an example, the step of deriving a secret key can be performed on a separate processing unit.

According to an aspect a method is provided for performing an instruction on a platform application, comprising the steps of:
preparing a persistent instruction on a user workplace application that is remotely connected to the platform application;
forwarding the persistent instruction to the platform application;
setting up a secure connection between the platform application and an authentication device;
performing an authorization dialog between the transaction system application and the authentication device; and
executing the transaction instruction only when the authorization dialog has successfully finished.

The step of setting up a secure connection between the platform application and the authentication device can be performed as described above. However, also other methods of setting up the secure connection are applicable. As an example, the platform application is a transaction system application and the instruction is a transaction instruction.

According to a further aspect, a platform application is provided that is remotely connected to a user workplace application and that has a secure connection with an authentication device, the platform application comprising a processor that is arranged for:
receiving a persistent instruction prepared on the user workplace;
performing an authorization dialog with the authentication device, via the secure connection; and
executing the instruction only when the authorization dialog has successfully finished.

According to yet a further aspect, a computer program product is provided for performing an instruction on a platform application, the computer program product comprising computer readable code for facilitating a processing unit to perform the steps of:
preparing a persistent instruction on a user workplace application that is remotely connected to the platform application;
forwarding the persistent instruction to the platform application;
setting up a secure connection between the platform application and an authentication device;
performing an authorization dialog between the transaction system application and the authentication device; and
executing the instruction only when the authorization dialog has successfully finished.

It will be understood that the above described embodiments of the invention are exemplary only and that other embodiments are possible without departing from the scope of the present invention. It will be understood that many variants are possible.

Such variants will be apparent for the person skilled in the art and are considered to fall within the scope of the invention as defined in the following claims.

1. A method for performing an instruction on a platform application, comprising the steps of:
preparing a persistent instruction on a user workplace application that is remotely connected to the platform application;
forwarding the persistent instruction to the platform application;
setting up a secure connection between the platform application and an authentication device;
performing an authorization dialog between the transaction system application and the authentication device; and
executing the instruction only when the authorization dialog has successfully finished.

2. A method according to claim 1, wherein the secure connection between the platform application and the authentication device is set up by providing a secure session between a first entity and a second entity, the first and second entity being a user authentication device and an application running on a platform, respectively, or vice versa, the method being performed by a first entity and comprising the steps of:
generating a first random number;
exporting a first string derived from said first random number, to a user for entering the first string into a second entity;
applying a one-way function to the first string or to a derivative thereof, obtaining an encoded string;
transmitting the encoded string to an intermediate node that is in connection to the first entity and a second entity,
the method further comprising the steps of:
generating a second random number, deriving a second string from said second random number and transmitting the second string to the second entity if a verifying step of comparing encoded strings transmitted by the first entity and the second entity has a positive result, or
receiving from the second entity a second string being derived from a second random number generated by the second entity,
the method further comprising the step of:
deriving a secret key from the first and the second string.

3. A method according to claim 1, wherein the secure connection between the platform application and the authentication device is set up by providing a secure session between a first entity and a second entity, the first and second entity being a user authentication device and an application running on a platform, respectively, or vice versa, the method being performed by a second entity and comprising the steps of:
receiving, via an I/O interface, a first string derived from a first random number generated by a first entity;
applying a one-way function to the first string or to a derivative thereof, obtaining an encoded string;
transmitting the encoded string to an intermediate node that is in connection to a first and the second entity;
the method further comprising the steps of:
generating a second random number, deriving a second string from said second random number and transmitting the second string to the first entity if a verifying step of comparing encoded strings transmitted by the first entity and the second entity has a positive result, or
receiving from the first entity a second string being derived from a second random number generated by the first entity,
the method further comprising the step of:
deriving a secret key from the first and the second string.

4. A method according to claim 1, wherein the secure connection between the platform application and the authentication device is set up by providing a secure session between a first entity and a second entity, the first and second entity being a user authentication device and an application running on a platform, respectively, or vice versa, the method being performed by an intermediate node that is in connection to the first and second entity, the method comprising the steps of:
receiving an encoded string from a first and second entity, the encoded string being obtained by applying a one-way function to a first string or to a derivative thereof, the first string being derived from a first random number generated by a first entity;
verifying whether the encoded strings received from the first and second entity are the same;
if the verifying step has a positive result, authorizing the first and second entity to share a second string being derived from a second random number generated by the first or second entity, respectively.

5. A method according to claim 1, wherein the platform application is a user workplace application, a cloud application, an authentication provider application, or a transaction system application.

6. A method according to claim 1, wherein the first string is first random number or a random message produced from said first random number.

7. A method according to claim 1, wherein, in the step of applying a one-way function, the derivative of the first string is obtained by performing a hash function to the first string.

8. A method according to claim 1, wherein the second string is transmitted in an encrypted manner.

9. A method according to claim 1, wherein the intermediate node is an authentication provider securely connected to the authentication device.

10. A method according to claim 1, wherein the secure session is used to support secure one-way or two-way data transfer, such as transfer of a message, a decryption and/or encryption key, or an authorization dialog.

11. A method according to claim 1, wherein the authorization dialog includes the steps of:
transmitting a code, from the transaction system application to the authentication device for entering the code into the user workplace application;
transmitting the code from the user workplace application to the transaction system application; and
verifying whether the code received by the transaction system application is the same as the code transmitted by said transaction system application.

12. A method according to claim 1, wherein the step of transmitting the second string is implemented by exporting the second string to a user, via an I/O interface of one entity, for manually entering the second string into an I/O interface of the other entity.

13. A method according to claim 1, further including a step of authorizing a document in a cloud application.

14. A method according to claim 1, wherein the authentication device includes a cellular phone, PDA, smart card, token or electronic key.

15. A platform application that is remotely connected to a user workplace application and that has a secure connection with an authentication device, the platform application comprising a processor that is arranged for:
receiving a persistent instruction prepared on the user workplace;
performing an authorization dialog with the authentication device, via the secure connection; and
executing the instruction only when the authorization dialog has successfully finished.

16. A platform application according to claim 15 being a first entity arranged for setting up a secure session with the authentication device being a second entity, the first entity comprising:
a first random generator for generating a first random number;
an I/O interface for exporting a first string derived from said first random number, to a user for entering the first string into a second entity;
a processor for applying a one-way function to the first string or to a derivative thereof, obtaining an encoded string;
a transmitting unit for transmitting the encoded string to an intermediate node that is in connection to the first entity and a second entity,
the first entity further comprising:
a second random generator for generating a second random number, wherein the processor is further arranged for deriving a second string from said second random number and for transmitting the second string to the second entity if a verifying step of comparing encoded strings transmitted by the first entity and the second entity has a positive result, or
a receiver unit for receiving from the second entity a second string being derived from a second random number generated by the second entity,
and wherein the processor is further arranged for deriving a secret key from the first and the second string.

17. An authentication device being a second entity arranged for setting up a secure session with a platform application according to claim 15 or 16, the second entity comprising:
an I/O interface for receiving a first string derived from a first random number generated by a first entity;
a processor for applying a one-way function to the first string or to a derivative thereof, obtaining an encoded string;
a transmitting unit for transmitting the encoded string to an intermediate node that is in connection to a first and the second entity;
the second entity further comprising:
a second random generator for generating a second random number, wherein the processor is arranged for deriving a second string from said second random number and for transmitting the second string to the first entity if a verifying step of comparing encoded strings transmitted by the first entity and the second entity has a positive result, or
a receiver unit for receiving from the first entity a second string being derived from a second random number generated by the first entity,
and wherein the processor is further arranged for deriving a secret key from the first and the second string.

18. An intermediate node that is in connection to a platform application according to claim 15, and to an authentication device for setting up a secure connection between the first and the second entity, the intermediate node comprising:
a receiving unit for receiving an encoded string from a first and second entity, the encoded string being obtained by applying a one-way function to a first string or to a derivative thereof, the first string being derived from a first random number generated by a first entity;
a processor for verifying whether the encoded strings received from the first and second entity are the same,
wherein the processor is further arranged for authorizing the first and second entity to share a second string being derived from a second random number generated by the first or second entity, respectively, if the verifying step has a positive result.

19. A network, comprising a platform application according to claim 15, an authentication device, and an intermediate node.

20. A computer program product for performing an instruction on a platform application, the computer program product comprising computer readable code for facilitating a processing unit to perform the steps of:
preparing a persistent instruction on a user workplace application that is remotely connected to the platform application;
forwarding the persistent instruction to the platform application;
setting up a secure connection between the platform application and an authentication device;
performing an authorization dialog between the transaction system application and the authentication device; and
executing the instruction only when the authorization dialog has successfully finished.

21. A computer program product according to claim 20, wherein the secure session between the platform application and the authentication device is set up by performing the steps of:
generating a first random number;
exporting a first string derived from said first random number, to a user for entering the first string into a second entity;
applying a one-way function to the first string or to a derivative thereof, obtaining an encoded string;
transmitting the encoded string to an intermediate node that is in connection to the first entity and a second entity,
further comprising the steps of:
generating a second random number, deriving a second string from said second random number and transmitting the second string to the second entity if a verifying step of comparing encoded strings transmitted by the first entity and the second entity has a positive result, or
receiving from the second entity a second string being derived from a second random number generated by the second entity,
and further comprising the step of:
deriving a secret key from the first and the second string.

22. A computer program product according to claim 20, wherein the secure session between the platform application and the authentication device is set up by performing the steps of:
receiving, via an I/O interface, a first string derived from a first random number generated by a first entity;
applying a one-way function to the first string or to a derivative thereof, obtaining an encoded string;
transmitting the encoded string to an intermediate node that is in connection to a first and the second entity;
further comprising the steps of:
generating a second random number, deriving a second string from said second random number and transmitting the second string to the first entity if a verifying step of comparing encoded strings transmitted by the first entity and the second entity has a positive result, or
receiving from the first entity a second string being derived from a second random number generated by the first entity,
and further comprising the step of:
deriving a secret key from the first and the second string.

23. A computer program product according to claim 20, wherein the secure session between the platform application and the authentication device is set up by performing the steps of:
receiving an encoded string from a first and second entity, the encoded string being obtained by applying a one-way function to a first string or to a derivative thereof, the first string being derived from a first random number generated by a first entity;
verifying whether the encoded strings received from the first and second entity are the same;
if the verifying step has a positive result, authorizing the first and second entity to share a second string being derived from a second random number generated by the first or second entity, respectively.
